(19) United States
(12) Patent Application Publication
(10) Pub. No.: US 2017/0150133 A1
(43) Pub. Date: May 25, 2017

(54) THREE-DIMENSIONAL DISPLAY

(71) Applicant: NATIONAL INSTITUTE OF INFORMATION AND COMMUNICATIONS TECHNOLOGY, Tokyo (JP)

(72) Inventor: Shunsuke YOSHIDA, Tokyo (JP)

(73) Assignee: NATIONAL INSTITUTE OF INFORMATION AND COMMUNICATIONS TECHNOLOGY, Tokyo (JP)

(21) Appl. No.: 15/323,297

(22) PCT Filed: Jun. 15, 2015
(86) PCT No.: PCT/JP2015/002987

§ 371 Date: Dec. 30, 2016

(30) Foreign Application Priority Data
Jul. 1, 2014 (JP) 2014-136200

(51) Int. Cl. H04N 13/04

(52) U.S. Cl. CPC H04N 13/0418; H04N 13/0497

(57) ABSTRACT

In a light ray controller, a light transmission diffusion layer and a light reflection layer are laminated on each other. The light ray controller is arranged such that the light transmission diffusion layer is located between a rotation center axis and the light reflection layer. A light ray generator emits a light ray group including a plurality of light rays towards the light transmission diffusion layer rotated by a rotation module. The light transmission diffusion layer transmits the light ray group while diffusing it in a vertical direction. The light reflection layer reflects the light ray group that has been transmitted through the light transmission diffusion layer. Based on three-dimensional data, the light ray generator is controlled by a control device such that a three-dimensional image is presented by the light ray group that has been reflected by the light reflection layer and transmitted through the light transmission diffusion layer.

### TECHNICAL FIELD

The present invention relates to a three-dimensional display that presents a three-dimensional image.

### BACKGROUND ART

Various types of three-dimensional displays that present three-dimensional images have been developed (see Patent Document 1, for example.) In a three-dimensional display, a three-dimensional image is generally presented to a space in front of, above or the like of a screen.

The three-dimensional display described in Patent Document 1 has a light ray controller having a cone shape. The light ray controller is arranged such that a bottom of the cone shape is open on a reference plane. A rotation base to which a plurality of scanning projectors are fixed are provided below the reference plane. Each scanning projector irradiates an outer peripheral surface of the light ray controller with a light ray group including a plurality of light rays from outside of the light ray controller while rotating on the rotation base about a rotation axis. The light ray controller transmits each light ray emitted by each scanning projector without diffusing it in a circumferential direction. Thus, a three-dimensional image is displayed above and inside the light ray controller having a cone shape.

[Patent Document 1] JP 2011-48273 A

### SUMMARY OF INVENTION

### Technical Problem

In the three-dimensional display such as the one described in Patent Document 1, the light ray group to be emitted by each scanning projector is calculated by a controller such that, in the case where an observer views a space above and inside the light ray controller from a position around the light ray controller, a three-dimensional image is displayed. This calculation is performed with the use of the large number of parameters such as positions of viewing points of the observer, a position of each scanning projector, a position of the light ray controller and the like. The larger the number of such parameters is, the more complicated calculation for accurately displaying the three-dimensional image becomes. Therefore, the three-dimensional display capable of displaying an accurate three-dimensional image more easily is desired.

An object of the present invention is to provide a three-dimensional display capable of easily displaying an accurate three-dimensional image.

### Solution to Problem

(1) A three-dimensional display for presenting a three-dimensional image based on three-dimensional data according to the present invention includes a light ray generator that emits a light ray group including a plurality of light rays;

a light ray controller that includes a light transmission diffusion layer and a light reflection layer laminated on each other, and a rotation mechanism that rotates the light ray controller about a rotation center axis, and a controller that controls the light ray generator, wherein the light ray controller is arranged such that the light transmission diffusion layer is located between the rotation center axis and the light reflection layer, the light ray generator is provided to emit the light ray group towards the light transmission diffusion layer of the light ray controller rotated by the rotation mechanism, the light transmission diffusion layer is formed to transmit the incident light ray group while diffusing the light ray group in a vertical direction, the light reflection layer is formed to reflect the light ray group that has been transmitted through the light transmission diffusion layer, and the controller, based on the three-dimensional data, controls the light ray generator such that a three-dimensional image is presented by the light ray group that has been reflected by the light reflection layer and transmitted through the light transmission diffusion layer.

In this three-dimensional display, the light ray controller is arranged such that the light transmission diffusion layer is located between the rotation center axis and the light reflection layer. The light ray generator emits the light ray group including the plurality of light rays towards the light transmission diffusion layer of the light ray controller rotated by the rotation mechanism.

In this case, the light transmission diffusion layer transmits the light ray group emitted by the light ray generator and transmits it while diffusing it in the vertical direction. The light reflection layer reflects the light ray group that has been transmitted through the light transmission diffusion layer. The light transmission diffusion layer transmits the light ray group reflected by the light reflection layer while further diffusing it in the vertical direction.

The light ray generator is controlled by the controller based on the three-dimensional data such that the three-dimensional image is presented by the light ray group that has been reflected by the light reflection layer and transmitted through the light transmission diffusion layer. Thus, the observer who has observed the light ray group that has been reflected by the light reflection layer and transmitted through the light transmission diffusion layer can visually recognize the three-dimensional image.

Because the light transmission diffusion layer and the light reflection layer of the light ray controller are laminated on each other, no light path is present between the light transmission diffusion layer and the light reflection layer. Therefore, in the calculation of the light ray group to be emitted by the light ray generator, a positional relationship between the light transmission diffusion layer and the light reflection layer can be excluded from fluctuating parameters. Thus, the calculation process of the light ray group is simplified. Further, the light ray controller can be manufactured easily by the laminate of the light transmission diffusion layer and the light reflection layer. Further, adjustment of the positional relationship between the light transmission diffusion layer and the light reflection layer is unnecessary. As a result, the accurate three-dimensional image can be more easily displayed.

(2) The rotation mechanism may rotate the light ray generator about the rotation center axis together with the light ray controller.

In this case, the light ray generator can emit the light ray group towards the light transmission diffusion layer of the rotating light ray controller with a simple configuration.

(3) The plurality of light ray controllers may be provided, the plurality of light ray generators may be provided to respectively correspond to the plurality of light ray controllers, and the plurality of light ray generators may be provided to emit the light ray group towards the respectively corresponding light ray controllers.

In this case, even in the case where the rotation speed of the light ray generator by the rotation mechanism is relatively low, it is possible to present a three-dimensional image having low flicker (flicking of emission points) and high time resolution.

(4) The plurality of light ray controllers and the plurality of light ray generators may be arranged around the rotation center axis at equal angular intervals.

In this case, the rotation of the plurality of light ray controllers and the plurality of light ray generators by the rotation mechanism can be more sufficiently stabilized. Further, the light ray generator can be more easily controlled by the controller.

(5) The light ray generator may be arranged to emit the light ray group in a direction of the rotation center axis, a mirror that reflects the light ray group emitted by the light ray generator towards the light ray controller may be further provided, and the rotation mechanism may rotate the mirror about the rotation center axis together with the light ray controller.

In this case, the light ray group is emitted to the light transmission diffusion layer of the rotating light ray controller via the rotating mirror. Thus, the light ray generator can emit the light ray group towards the light transmission diffusion layer of the rotating light ray controller with a simple configuration.

(6) The three-dimensional display may further include a detector that detects eye positions of an observer, wherein the controller may control the light ray generator based on the eye positions detected by the detector.

In the case where the eye position of the observer is changed, the three-dimensional image visually recognized by the observer is deformed. Even in such a case, it is possible to prevent deformation of the three-dimensional image caused by the eye position of the observer by controlling the light ray generator based on the eye positions detected by the detector.

(7) The controller may control a color of a light ray emitted to the light ray controller by the light ray generator for each rotation position of the light ray controller.

In this case, a plurality of point light sources having respective colors are produced at crossing points of the plurality of light rays controlled for each rotation position of the light ray controller. Thus, the color three-dimensional image having low flicker and high time resolution can be presented.

### Advantageous Effects of Invention

The present invention enables an accurate three-dimensional image to be easily displayed.

### BRIEF DESCRIPTION OF DRAWINGS

FIG. 1 is a schematic cross sectional view of a three-dimensional display according to one embodiment of the present invention.

FIG. 2 is a schematic plan view of the three-dimensional display of FIG. 1.

FIG. 3 is a diagram for explaining a configuration and functions of a light ray controller in the three-dimensional display of FIG. 1.

FIG. 4 is a schematic plan view for explaining an operation of a light ray generator.

FIG. 5 is an enlarged plan view of an area in the vicinity of the light ray controller of FIG. 4.

FIG. 6 is a schematic plan view for explaining a method of presenting a three-dimensional image.

FIG. 7 is a schematic cross sectional view for explaining the method of presenting the three-dimensional image.

FIG. 8 is a schematic plan view for explaining a principle of generation of binocular parallax in the three-dimensional display according to the present embodiment.

FIG. 9 is a diagram for explaining correction of the light ray group in the case where an eye of an observer is located outside of an annular viewing area.

FIG. 10 is a schematic diagram showing a configuration of a three-dimensional display according to a first modified example.

FIG. 11 is a schematic diagram showing a configuration of a three-dimensional display according to a second modified example.

FIG. 12 is a schematic diagram showing a configuration of a three-dimensional display according to a third modified example.

FIG. 13 is a schematic diagram showing a configuration of a three-dimensional display according to a fourth modified example.

FIG. 14 is a schematic diagram showing a configuration of a three-dimensional display according to a fifth modified example.

### DESCRIPTION OF EMBODIMENTS

A three-dimensional display according to one embodiment of the present invention will be described below with reference to the drawings.

(1) Configuration of Three-Dimensional Display

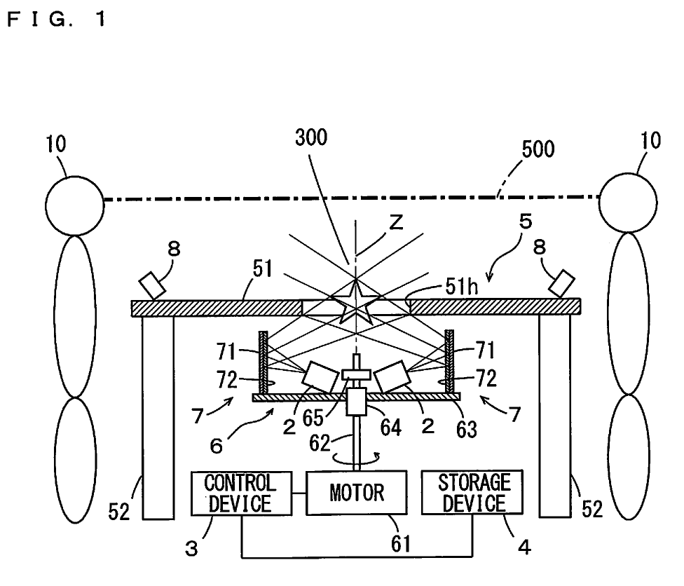

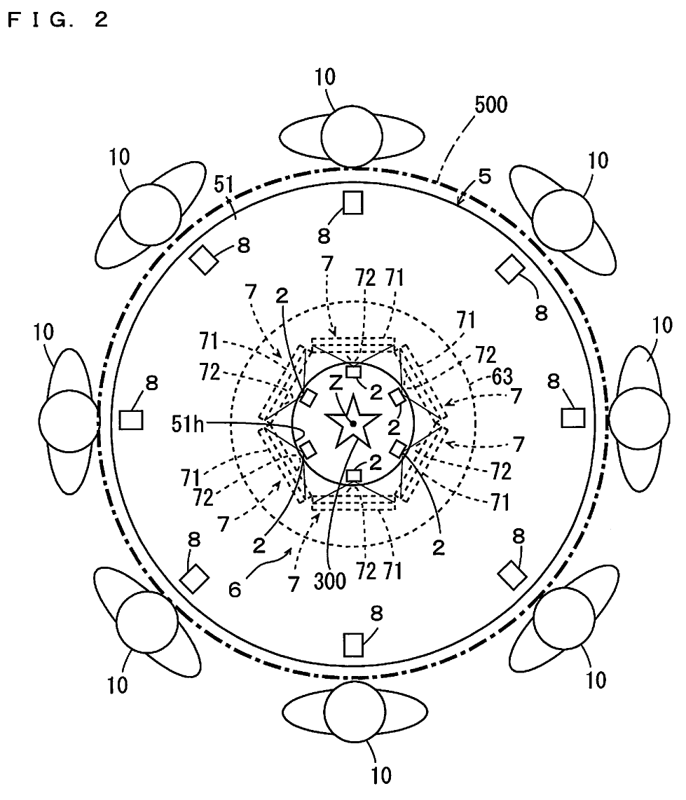

FIG. 1 is a schematic cross sectional view of the three-dimensional display according to the one embodiment of the present invention. FIG. 2 is a schematic plan view of the three-dimensional display of FIG. 1.

As shown in FIG. 1, the three-dimensional display is constituted by one or a plurality of light ray generators 2, a control device 3, a storage device 4, a rotation module 6, one or a plurality of light ray controllers 7 and a plurality of cameras 8. The control device 3 is constituted by a personal computer, for example. The storage device 4 is constituted by a hard disc and a memory card, for example. Three-dimensional data for presenting a three-dimensional image 300 is stored in the storage device 4.

Constituents that constitute the three-dimensional display of each of FIGS. 1 and 2 are provided under a table 5. The table 5 is constituted by a circular top board 51 and a plurality of legs 52. The top board 51 has a circular hole 51h at the center. The shape of the hole 51h is not limited to a circle, but may be a polygon such as a triangle or a square, an oval or another shape. Further, a transparent plate may be fitted into the hole 51h of the table 5 . Observers 10 who are present around the table 5 can observe an area in the vicinity of the center of the top board 51 from obliquely above the top board 51 of the table 5.

The rotation module 6 is provided under the table 5. The rotation module 6 is constituted by a motor 61, a rotation shaft 62, a rotation base 63, a signal transmission device 64 and a rotation amount measuring device 65. The rotation shaft 62 is attached to the motor 61 so as to extend in a vertical direction and be located on a straight line common to a central axis Z of the top board 51.

The rotation base 63 is attached to the rotation shaft 62 in a horizontal attitude. The signal transmission device 64 is provided at the rotation shaft 62 and the rotation base 63. The signal transmission device 64 is a device for transmitting electric power or signals between a stationary body and a rotary body. As the signal transmission device 64, a slip ring or an optical rotary joint, for example, can be used.

Further, a rotation amount measuring device 65 is provided at the rotation shaft 62. The rotation amount measuring device 65 is used to detect a rotation position of the rotation shaft 62. As the rotation amount measuring device 65, a rotary encoder can be used, for example. The motor 61 is controlled by the control device 3. In the case where the motor 61 is a mechanism capable of strictly controlling a rotation amount of a stepper motor and the like, the rotation amount measuring device 65 is not absolutely necessary.

The one or plurality of light ray generators 2 and the one or plurality of light ray controllers 7 are fixed to the upper surface of the rotation base 63. In the present embodiment, the plurality of light ray generators 2 and the plurality of light ray controllers 7 are fixed to the upper surface of the rotation base 63. The plurality of light ray generators 2 respectively correspond to the plurality of light ray controllers 7. Thus, even in the case where the rotation speed of the light ray generators 2 is relatively low, the three-dimensional image 300 having low flicker (flickering of emission points) and high time resolution can be presented.

Each light ray generator 2 is a scanning projector, for example. Each light ray generator 2 can emit a light ray and deflect the light ray in horizontal and vertical planes. Thus, each light ray generator 2 can scan an incidence emission surface of a light transmission diffusion layer 72, described below, of the light ray controller 7 with the light ray. The light ray here refers to non-diffusing light represented by a straight line. The plurality of light ray generators 2 are arranged on a circumference centered at a center axis Z at equal angular intervals in the vicinity of the rotation shaft 62 on the rotation base 63. The plurality of light ray generators 2 are provided to emit a light ray group including a plurality of light rays obliquely outward and upward.

The light ray generator 2 may be a general projector including a projection system such as a spatial light modulator and a lens array including a plurality of lenses. In the case where an aperture (an opening) of the projection system is sufficiently small, a light ray group can be formed similarly to the scanning projector. The spatial light modulator is a DMD (a Digital Micromirror Device), an LCD (a Liquid Crystal Display) or an LCOS (a Liquid Crystal on Silicon), for example.

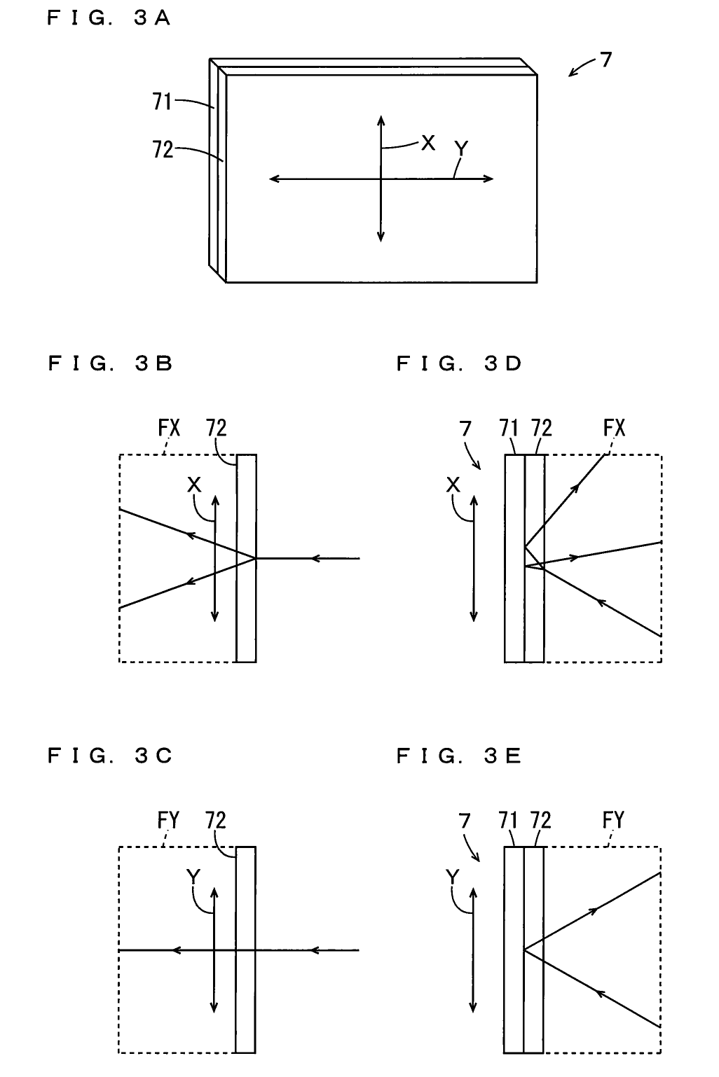

FIGS. 3(a) to 3(e) are diagrams for explaining a configuration and functions of the light ray controller 7 in the three-dimensional display of FIG. 1. As shown in FIG. 3(a), each light ray controller 7 has a configuration in which a light reflection layer 71 and a light transmission diffusion layer 72 are laminated. In the present example, the light reflection layer 71 is a mirror having a planar reflection surface. The light reflection layer 71 may be a sheet-like member or a plate-like member, or may be a reflection film that is formed by application of a paint on one surface of the light transmission diffusion layer 72. The light transmission diffusion layer 72 may be a lenticular sheet or a holographic screen. The light transmission diffusion layer 72 may have a configuration in which a resin layer including a fine light diffusion material is formed on a surface of a flat sheet-like member having transmissibility. In this case, the fine light diffusion material has an oval shape or a fiber form, for example.

The light transmission diffusion layer 72 is formed to have different configurations in a first direction X and a second direction Y orthogonal to each other. A plane that intersects with the light transmission diffusion layer 72 in the first direction X is referred to as a first plane FX, and a plane that intersects with the light transmission diffusion layer 72 in the second direction Y is referred to as a second plane FY. A light ray incident on the light transmission diffusion layer 72 is transmitted while being largely diffused in the first direction X in the first plane FX as shown in FIG. 3(b), and travels substantially in a straight line and is transmitted while subtly being diffused in the second plane FY as shown in FIG. 3(c).

In this manner, a diffusion angle in the second direction Y of the light ray that has been transmitted through the light transmission diffusion layer 72 is smaller than a diffusion angle in the first direction X of the light ray. The diffusion angle in the second direction Y may be 1/10 or less than 1/10 of the diffusion angle in the first direction X. For example, the diffusion angle in the second direction Y is smaller than the diffusion angle in the first direction X. In the present embodiment, the diffusion angle in the first direction X is 60 degrees, for example, and the diffusion angle in the second direction Y is 1 degree, for example. The diffusion angle in the second direction Y is not limited to this and may be smaller than 1 degree, for example.

The plurality of light ray controllers 7 are arranged such that the first direction X of the light transmission diffusion layer 72 coincides with the vertical direction parallel to the center axis Z, and are arranged such that the second direction Y coincides with the horizontal direction. As shown in FIG. 3(d), the light ray incident on the light transmission diffusion layer 72 of the light ray controller 7 is transmitted through the light transmission diffusion layer 72 while being largely diffused in the first direction X in the first plane FX and reflected by the reflection surface of the light reflection layer 71. The light ray reflected by the reflection surface of the light reflection layer 71 is transmitted again through the light transmission diffusion layer 72 while being largely diffused in the first direction X in the first plane FX and emitted from the surface of the light transmission diffusion layer 72.

As shown in FIG. 3(e), the light ray incident on the light transmission diffusion layer 72 of the light ray controller 7 travels substantially in a straight line and is transmitted through the light transmission diffusion layer 72 while being subtly diffused in the second plane FY and is reflected by the reflection surface of the light reflection layer 71. The light ray reflected by the reflection surface of the light reflection layer 71 travels substantially in a straight line and is transmitted again through the light transmission diffusion layer 72 while being subtly diffused in the second plane FY, and is emitted from the surface of the light transmission diffusion layer 72.

Further, as shown in FIG. 2, the plurality of light ray controllers 7 are arranged on the circumference centered at the center axis Z at equal angular intervals such that the light transmission diffusion layers 72 are respectively opposite to the plurality of light ray generators 2. The plurality of light ray generators 2 and the plurality of light ray controllers 7 do not have to be arranged necessarily at equal angular intervals. However, in order to stabilize the rotation of the rotation base 63 and easily control the plurality of light ray generators 2, the plurality of light ray generators 2 and the plurality of light ray controllers 7 are preferably arranged at equal angular intervals as described in the present embodiment.

A surface of the light transmission diffusion layer 72 facing the light ray generator 2 in each light ray controller 7 is referred to as an incidence emission surface. In the present embodiment, the light transmission diffusion layer 72 has the planar incidence emission surface. A light ray group emitted from each light ray generator 2 is incident on the incidence emission surface of the light transmission diffusion layer 72 of the corresponding light ray controller 7, transmitted while being diffused in the vertical direction by the light transmission diffusion layer 72 and reflected by the light reflection layer 71. The light ray group reflected by the light reflection layer 71 is transmitted while being further diffused in the vertical direction by the light reflection layer 71 and emitted from the incidence emission surface of the light transmission diffusion layer 72. The light ray group emitted from the incidence emission surface of the light transmission diffusion layer 72 is led upward from below the top board 51 through the hole 51h of the top board 51.

The plurality of light ray generators 2 on the rotation base 63 and the rotation amount measuring device 65 are connected to the control device 3 through the signal transmission device 64. The rotation shaft 62 is rotated together with the rotation base 63, the plurality of light ray generators 2 and the plurality of light ray controllers 7 by an operation of the motor 61. In this case, a light ray group emitted from the each rotating light ray generator 2 is diffused in the vertical direction and reflected by the corresponding light ray controller 7.

As described in the example of FIG. 2, in the case where the number of the light ray generators 2 is 6, the rotation speed of the rotation base 63 is preferably 5 or more than 5 rotations per second. In the case where the number of the light ray generators 2 is 4, the rotation speed of the rotation base 63 is preferably 7.5 or more than 7.5 rotations per second. In the case where the number of light ray generators 2 is 3, the rotation speed of the rotation base 63 is preferably 10 or more than 10 rotations per second.

In the case where the number of light ray generators 2 is 2, the rotation speed of the rotation base 63 is preferably 15 or more than 15 rotations per second. In the case where the number of light ray generators 2 is 1, the rotation speed of the rotation base 63 is preferably 30 or more than 30 rotations per second. That is, in the case where the number of the light ray generators 2 is n (n is a natural number), the rotation speed of the rotation base 63 is preferably 30/n or more than 30/n rotations per second.

The control device 3 controls the plurality of light ray generators 2 based on the three-dimensional data stored in the storage device 4. Thus, the three-dimensional image 300 is presented above and below the hole 51h of the top board 51.

The plurality of cameras 8 are arranged to pick up images of faces of the observers 10 present around the table 5. Image data acquired by the plurality of cameras 8 is provided to the control device 3. The control device 3 calculates eye positions (viewpoints) of each observer 10 based on the image data provided from the plurality of cameras 8 and makes a correction of a light ray group by eye tracking, described below.

(2) Operation of Light Ray Generator

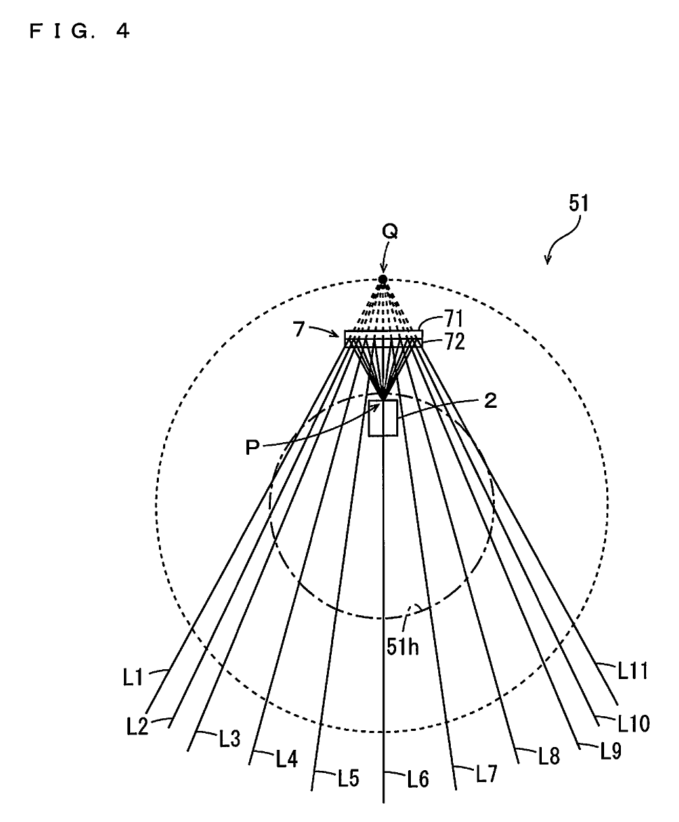

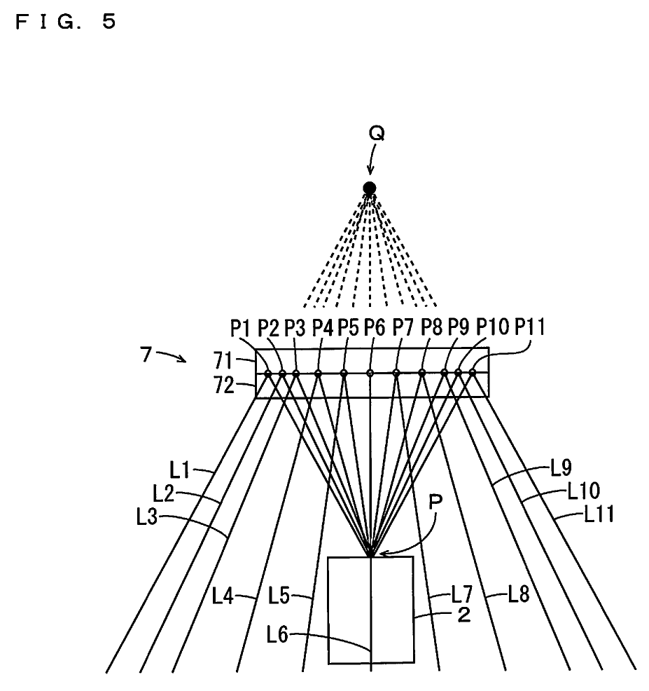

FIG. 4 is a schematic plan view for explaining an operation of the light ray generator 2. FIG. 5 is an enlarged plan view of an area close to the light ray controller 7 of FIG. 4.

Only one light ray generator 2 is shown in each of FIGS. 4 and 5. As shown in each of FIGS. 4 and 5, the light ray generator 2 has a light ray emission port P from which light rays made of laser light are emitted. The light ray generator 2 can emit light rays from the light ray emission port P and deflect the light rays in the horizontal and vertical planes as described above.

The light ray generator 2 can scan the incidence emission surface of the light transmission diffusion layer 72 in the horizontal direction with the light rays by deflecting the light rays in the horizontal plane. Further, the light ray generator 2 can scan the incidence emission surface of the light transmission diffusion layer 72 in the vertical direction with the light rays by deflecting the light rays in the vertical plane. Thus, the light ray generator 2 can scan the incidence emission surface of the light transmission diffusion layer 72 with the light rays.

Further, the light ray generator 2 can set the color for a light ray in each light ray direction. Thus, the light ray generator 2 emits a light ray group including a plurality of light rays in a pseudo manner.

In FIG. 4, the light ray generator 2 irradiates the light ray controller 7 with a plurality of light rays L1 to L11. The colors of the light rays L1 to L11 are respectively set to any colors. Thus, the light rays L1 to L11 in respectively set colors are transmitted through the light transmission diffusion layer 72 of the light ray controller 7 and reflected in a plurality of positions P1 to P11 of the reflection surface of the light reflection layer 71 (FIG. 5). The plurality of light rays L1 to L11 reflected in the plurality of positions P1 to P11 are transmitted again through the light transmission diffusion layer 72.

Because the light transmission diffusion layer 72 transmits the light rays L1 to L11 substantially in a straight line while hardly diffusing them in the horizontal direction, the observer 10 can visually recognize only substantially a single light ray in a certain position. Further, because the light ray controller 7 transmits the light rays L1 to L11 while largely diffusing them in the vertical direction, the observer 10 can visually recognize substantially a single light ray in any position in the vertical direction.

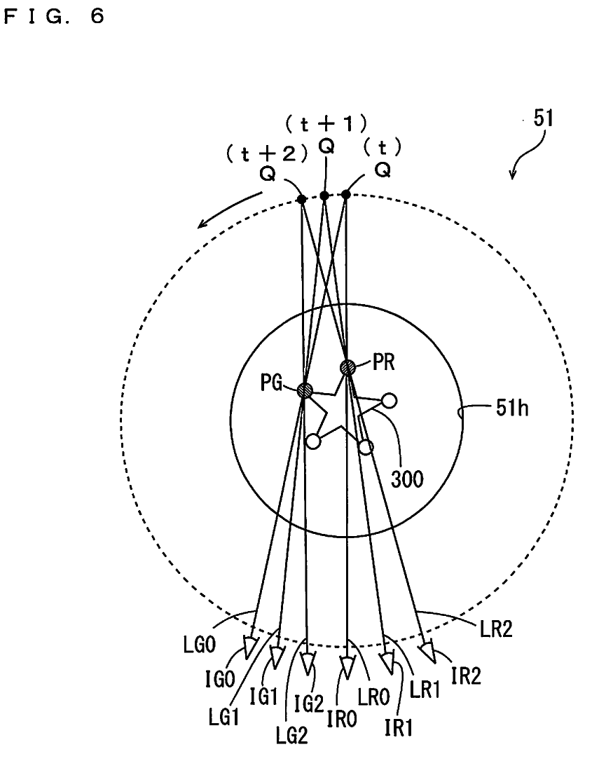

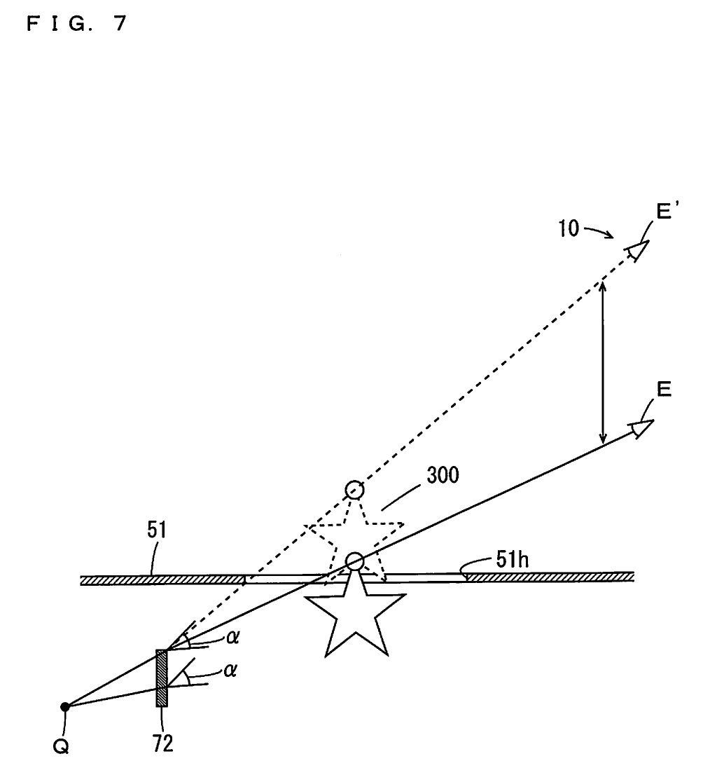

As shown in each of FIGS. 4 and 5, a point, which is plane-symmetric with the light ray emission port P of the light ray generator 2 with respect to the reflection surface of the light reflection layer 71 is referred to as a virtual emission point Q. The configuration in which a light ray group emitted from the light ray emission port P of the light ray generator 2 is reflected by the light reflection layer 71 and diffused by the light transmission diffusion layer 72 is substantially equivalent to the configuration in which a light ray group emitted from the virtual emission point Q is diffused by the light transmission diffusion layer 72. Then, in each of next FIGS. 6 and 7, in order to facilitate understanding, the light ray generator 2 is not shown, and a method of presenting the three dimensional image 300 will be described with the use of a model in which the light ray group is emitted from the virtual emission point Q.

(3) Method of Presenting Three-Dimensional Image

FIG. 6 is a schematic plan view for explaining the method of presenting the three-dimensional image 300. In FIG. 6, the virtual emission point Q corresponding to one light ray generator 2 is shown. In FIG. 6, the light ray controller 7 is not shown.

The virtual emission point Q moves in a direction of an arrow. A moving direction of the virtual emission point Q is not limited to the direction of the arrow of FIG. 6 (a counterclockwise direction) but may be a clockwise direction. For example, in the case where a red pixel is presented in a position PR above or below the hole 51h of the top board 51, a red light ray LR0 is emitted in a direction passing through the position PR from the virtual emission point Q at a time point t, a red light ray LR1 is emitted in a direction passing through the position PR from the virtual emission point Q at a time point t+1 and a red light ray LR2 is emitted in a direction passing through the position PR from the virtual emission point Q at a time point t+2.

Thus, the red pixel to be a point light source is presented at a crossing point of the red light rays LR0, LR1, LR2. In this case, in the case where an eye of the observer 10 is in each of the positions IR0, IR1, IR2, the red pixel is viewed in the position PR.

Similarly, in the case where a green pixel is presented in a position PG above or below the hole 51h of the top board 51, a green light ray LG0 is emitted in a direction passing through the position PG from the virtual emission point Q at the time point t, a green light ray LG1 is emitted in a direction passing through the position PG from the virtual emission point Q at the time point t+1 and a green light ray LG2 is emitted in a direction passing through the position PG from the virtual emission point Q at the time point t+2.

Thus, the green pixel to be a point light source is presented at a crossing point of the green light rays LG0, LG1, LG2. In this case, in the case where the eye of the observer 10 is in each of the positions IG0, IG1, IG2, the green pixel is viewed in the position PG.

In this manner, the light rays in colors to be presented are emitted in directions passing through positions of the three-dimensional image 300 from the virtual emission points Q located in the time-divisionally different positions.

The spaces above and below the hole 51h of the top board 51 are sufficiently densely filled with a light point group of crossing light rays by the control of the light ray group emitted from each rotating virtual emission point Q for each small angular interval. Thus, even in the case where the spaces above and below the hole 51h of the top board 51 are observed in any direction on the circumference, appropriate light rays passing through the positions PR, PG are incident on a human eye. Therefore, the human eye_perceive it as if point light sources exist there. Because a person recognizes illumination light reflected or diffused at the surface of a real object as an object, the surface of the object can be considered as the collection of point light sources. That is, the three-dimensional image 300 can be presented by appropriate reproduction of the colors of the positions PR and PG to be a surface of the object by the light rays emitted from each virtual emission point Q.

In this manner, the three-dimensional image 300 can be presented in the spaces above and below the hole 51h of the top board 51. In this case, the observer 10 can visually recognize the same three-dimensional image 300 in different positions in the circumferential direction and in respective different directions.

FIG. 7 is a schematic cross sectional view for explaining the method of presenting the three-dimensional image 300. In FIG. 7, the virtual emission point Q is shown instead of one light ray generator 2.

As shown in FIG. 7, light rays emitted from the virtual emission point Q are diffused in the vertical direction at a diffusion angle a by the light transmission diffusion layer 72. Thus, the observer 10 can view the light ray in the same color emitted from the virtual emission point Q in different positions in the vertical direction within the range of the diffusion angle α. For example, even in the case where the observer 10 moves his/her line of sight from a reference position E to an upper position E′, the observer 10 can view the same part of the three-dimensional image 300. In this case, the position of the three-dimensional image 300 visually recognized by the observer 10 moves depending on the eye positions of the observer 10 in the vertical direction. In this manner, because the light rays emitted from the virtual emission point Q are diffused in the vertical direction by the light transmission diffusion layer 72, the three-dimensional image 300 can be observed even when the observer 10 moves his/her line of sight upward and downward.

The color of each light ray in the light ray group emitted from each virtual emission point Q is calculated by the control device 3 for each rotation position of each virtual emission point Q and each scanning position of the light ray based on the three-dimensional data stored in the storage device 4. The rotation position of the virtual emission point Q refers to a rotation angle of the virtual emission point Q in a reference radial direction centered at the center axis Z.

Specifically, the control device 3 finds a crossing point of a three-dimensional plane that is defined in advance as three-dimensional data and each light ray and calculates the appropriate color to be provided to the light ray. The control device 3 determines a rotation position of each virtual emission point Q based on an output signal of the rotation amount measuring device 65 and controls each light ray generator 2 based on the color of each light ray in the light ray group calculated for each rotation position and each scanning position of the light ray. Thus, the light rays respectively having the calculated colors are emitted from each virtual emission point Q such that the three-dimensional image 300 is presented above and below the hole 51h of the top board 51. Thus, the color three-dimensional image 300 having low flicker and high time resolution can be presented.

In this case, the control device 3 may calculate the color of each light ray to be emitted from each virtual emission point Q as color data in advance based on the three-dimensional data for each rotation position and each scanning position of the light ray and may store the calculated color data in the storage device 4. Then, at the time of presentation of the three-dimensional image 300, the control device 3 may be synchronized with the output signal of the rotation amount measuring device 65, read out the color data from the storage device 4 and control each light ray generator 2 based on the read color data. Alternatively, the control device 3 may be synchronized with the output signal of the rotation amount measuring device 65 during the rotation of the virtual emission point Q, calculate the color of each light ray to be emitted from each virtual emission point Q as color data based on the three-dimensional data and control each light ray generator 2 based on the calculated color data.

As described above, the three-dimensional display according to the present embodiment enables directional display of the three-dimensional image 300.

(4) Principle of Generation of Binocular Parallax

The principle of generation of binocular parallax in the three-dimensional display according to the present embodiment will be described.

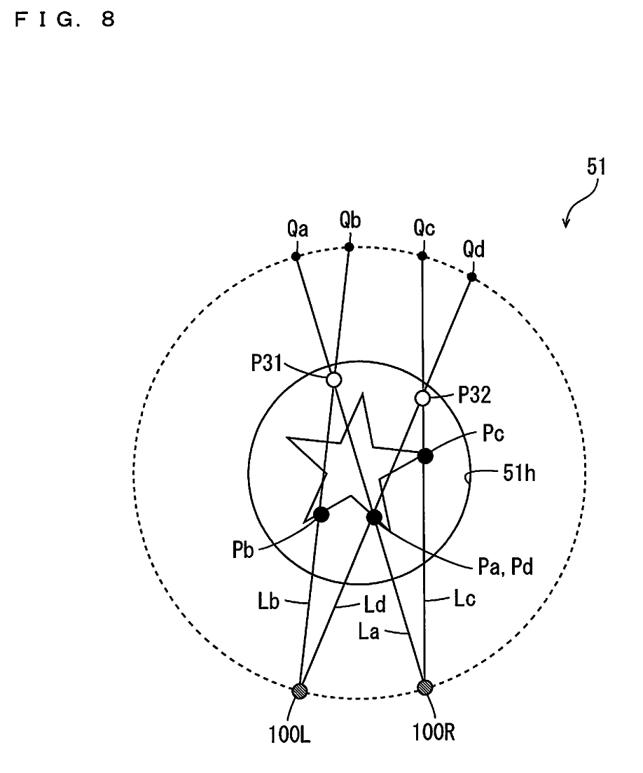

FIG. 8 is a schematic plan view for explaining the principle of generation of binocular parallax in the three-dimensional display according to the present embodiment. In FIG. 8, virtual emission points Q different from one another at four time points are shown. The virtual emission points Q at the four time points are respectively referred to as virtual emission points Qa, Qb, Qc, Qd.

In FIG. 8, in the case where the observer 10 views a point P31 above or below the hole 51h of the top board 51, a light ray La emitted from the virtual emission point Qa is incident on a right eye 100R, and a light ray Lb emitted from the virtual emission point Qb is incident on a left eye IDOL. Further, in the case where the observer 10 views a point P32 above or below the hole 51h of the top board 51, a light ray Lc emitted from the virtual emission point Qc is incident on the right eye 100R, and a light ray Ld emitted from the virtual emission point Qd is incident on the left eye IDOL.

Assume now that the color of the light ray La and the color of the light ray Ld are the same, the color of the light ray Lb is different from the color of the light ray La, and the color of the light ray Lc is different from the color of the light ray Ld. In this case, the color of the point P31 differs depending on viewing directions. The color of the point P32 also differs depending on viewing directions.

A point Pa of the three-dimensional image 300 is formed by the light ray La, a point Pb of the three-dimensional image 300 is formed by the light ray Lb, a point Pc of the three-dimensional image 300 is formed by the light ray Lc, and a point Pd of the three-dimensional image 300 is formed by the light ray Ld.

In the example in FIG. 8, the point Pa and the point Pd of the three-dimensional image 300 are in the same position. That is, the points Pa, Pd of the three-dimensional image 300 are formed at a crossing point of the light ray La and the light ray Ld. Therefore, the points Pa, Pd can be considered as virtual point light sources. In this case, the direction in which the right eye 100R views the points Pa, Pd is different from the direction in which the left eye 100L views the points Pa, Pd. That is, there is an angle of convergence between the line-of-sight direction of the right eye 100R and the line-of-sight direction of the left eye IDOL. Further, a positional relationship among the points Pa to Pd in the case where the right eye 100R views the points P31, P32 is different from a positional relationship among the points Pa to Pd in the case where the left eye 100L views the points P31, P32. That is, binocular parallax is generated. This enables an image formed by a light ray group to appear stereoscopic.

(5) Function of Correcting Light Ray Group by Eye Tracking

In the case where the plurality of observers 10 are seated around the table 5, it can be considered that eyes of the observers 10 are located in positions spaced apart from the center axis Z of the top board 51 by a substantially constant distance and at a substantially constant height (reference positions). Therefore, as shown in FIGS. 1 and 2, an annular region in which the eyes of the plurality of observers 10 are located is set as an annular viewing area 500.

The control device 3 controls each light ray generator 2 based on the assumption that the eyes of the plurality of observers 10 are in the annular viewing area 500. Thus, in the case where the eyes of the plurality of observers 10 are in the annular viewing area 500, the plurality of observers 10 can visually recognize the three-dimensional image 300 having the same shape at the same height.

As described above with reference to FIG. 7, the position of each pixel of the three-dimensional image 300 visually recognized by the observer 10 moves depending on the eye positions of the observer 10 in the vertical direction. Therefore, in the case where the eye of the observer 10 is located outside of the annular viewing area 500, the three-dimensional image 300 appears deformed.

Then, in the three-dimensional display according to the present embodiment, a light ray group emitted from each virtual emission point Q2 to the light transmission diffusion layer 72 is corrected based on the eye positions of each observer 10 detected by eye tracking with the camera 8.

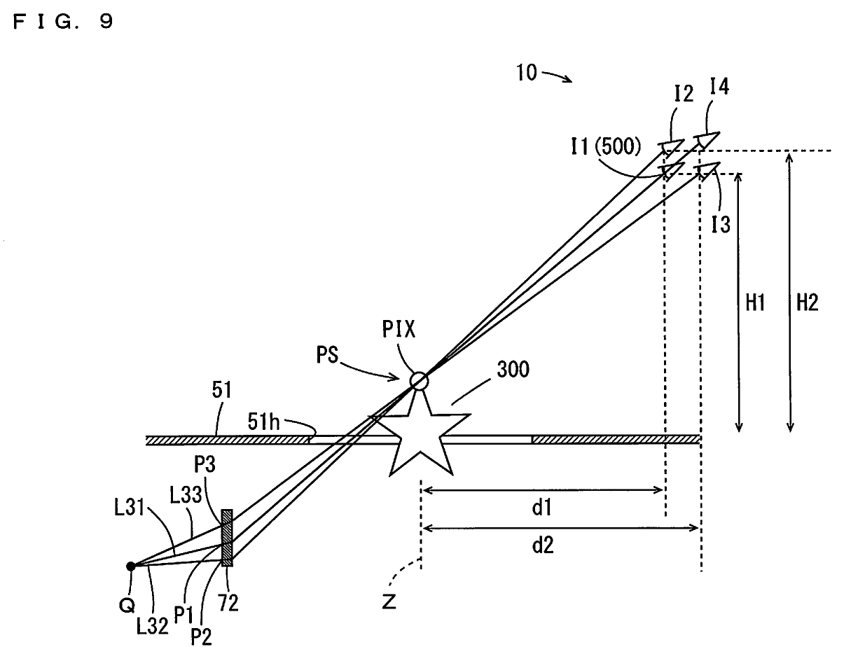

FIG. 9 is a diagram for explaining the correction of the light ray group in the case where the eye of the observer 10 is located outside of the annular viewing area 500.

In FIG. 9, the annular viewing area 500 is located in a position spaced apart from the center axis Z of the top board 51 in the horizontal direction by a distance dl and of which the height from the top board 51 of the table 5 is a height H1. A method of presenting one pixel PIX of the three-dimensional image 300 in a standard position PS above or below the hole 51h of the top board 51 will be described.

In the case where an eye of the observer 10 is in a position 11 in the annular viewing area 500, the position P1 of the light transmission diffusion layer 72 is irradiated with a light ray L31 having the color of the pixel PIX of the three-dimensional image 300 emitted from the virtual emission point Q. The light ray L31 with which the position P1 is irradiated is diffused in the vertical direction by the light transmission diffusion layer 72, and a single diffused light ray passes through the standard position PS and is incident on the eye of the observer 10 in the position 11. Thus, the observer 10 whose eye is in the position 11 can visually recognize the pixel PIX in the standard position PS.

In the case where the eye of the observer 10 is located in a position 12 at a height H2 higher than the annular viewing area 500, the position P2 of the light transmission diffusion layer 72 is irradiated with a light ray L32 having the color of the pixel PIX of the three-dimensional image 300 emitted from the virtual emission point Q. The light ray L32 with which the position P2 is irradiated is diffused in the vertical direction by the light transmission diffusion layer 72, and the single diffused light ray passes through the standard position PS and is incident on the eye of the observer 10 in the position 12. Thus, the observer 10 whose eye is in the position 12 can visually recognize the pixel PIX in the standard position PS.

In the case where the eye of the observer 10 is in the position 13 that is at the same height as that of the annular viewing area 500 and spaced apart from the center axis Z in the horizontal direction by a distance d2, a position P3 of the light transmission diffusion layer 72 is irradiated with a light ray L33 having the color of the pixel PIX of the three-dimensional image 300 emitted from the virtual emission point Q. The light ray L33 with which the position P3 is irradiated is diffused in the vertical direction by the light transmission diffusion layer 72, and the single diffused light ray passes through the standard position PS and is incident on the eye of the observer 10 in the position 13. Thus, the observer 10 whose eye is in the position 13 can visually recognize the pixel PIX in the standard position PS.

Specifically, the control device 3 calculates coordinates of the eye position of the observer 10 based on image data provided from the camera 8. In the case where the eye position of the observer 10 is in the annular viewing area 500, the control device 3 controls the light ray generator 2 such that the position P1 at which a straight line passing through the eye position and the standard position PS intersects with the light transmission diffusion layer 72 is irradiated with the light ray L31 having the color of the pixel PIX.

In the case where the eye of the observer 10 is located outside of the annular viewing area 500, the control device 3 controls the light ray generator 2 such that a position at which a straight line passing through the eye position and the standard position PS intersects with the light transmission diffusion layer 72 is irradiated with a light ray having the color of the pixel PIX.

In this manner, the control device 3 corrects the direction of the light ray for presenting the pixel PIX in the standard position PS according to the eye position of the observer 10. In other words, the control device 3 corrects the color of each light ray in the light ray group emitted from the virtual emission point Q such that the light ray having the color of the pixel PIX is incident on the eye of the observer 10 according to the eye position of the observer 10. As a result, the observer 10 can visually recognize the three-dimensional image 300 having the same shape regardless of the eye position.

In the case where the eye of the observer 10 is on the straight line passing through the annular viewing area 500 and the standard position PS, even when the eye of the observer 10 is located at a position 14 outside of the annular viewing area 500, the position P1 of the light transmission diffusion layer 72 is irradiated with the light ray L31 having the color of the pixel PIX of the three-dimensional image 300 emitted from the virtual emission point Q similarly to the case where the eye of the observer 10 is in the annular viewing area 500. Thus, the observer 10 can visually recognize the pixel PIX in the standard position PS.

In this manner, the light ray group emitted from the virtual emission point Q is corrected according to the eye position of the observer 10, whereby the three-dimensional image 300 is presented without deformation regardless of the eye position of the observer 10.

While the coordinates of the eye position of the observer 10 are calculated based on the image data provided from the camera 8 in the present embodiment, the present invention is not limited to this. For example, an object detection mechanism such as a radar or a sonar may be provided in the three-dimensional display, and the coordinates of the eye position of the observer 10 may be calculated based on the data provided from the object detection mechanism.

While the plurality of cameras 8 are provided to respectively correspond to the plurality of observers 10 in the above-mentioned embodiment, the present invention is not limited to this. One or a plurality of cameras 8 may be provided not to correspond to the one or plurality of observers 10. For example, one camera 8 may be provided to pick up an image or images of a face or faces of the one or plurality of observers 10.

(6) Modified Example

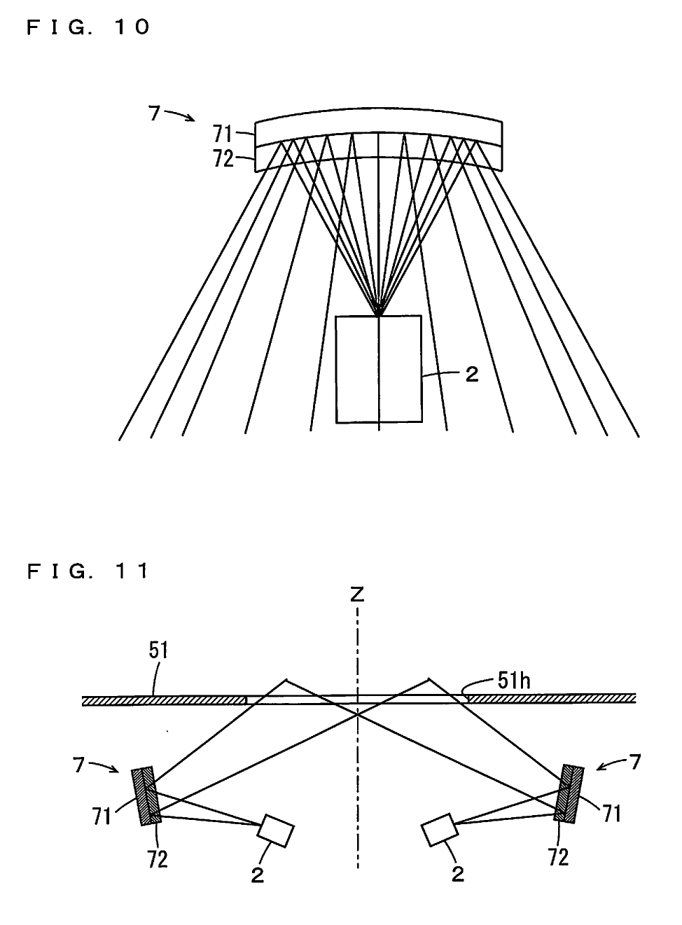

FIG. 10 is a schematic diagram showing a configuration of a three-dimensional display according to a first modified example. As shown in FIG. 10, a light reflection layer 71 in the first modified example is a mirror having a curved reflection surface. A light transmission diffusion layer 72 is a sheet having a curved incidence emission surface.

The reflection surface of the light reflection layer 71 and the incidence emission surface of the light transmission diffusion layer 72 may be a convexly curved surface or a concavely curved surface. In this case, a direction of a light ray reflected by the light ray controller 7 can be appropriately adjusted by adjustment of curvature of each of the reflection surface and the incidence emission surface.

In the case where the light ray generator 2 is a scanning projector, for example, an MEMS (Micro Electro Mechanical Systems) mirror reciprocates in the horizontal direction within a constant width, whereby the light rays scan the incidence emission surface in the horizontal and vertical directions. In the case where a reciprocation width of the reciprocating motion of the MEMS mirror is small, the motion of the MEMS mirror can be easily controlled. On the other hand, an angle of view of the light ray generator 2 in each of the horizontal and vertical directions is reduced.

Even in such a case, angular intervals between light rays in the horizontal and vertical directions reflected by a light ray controller 7 can be increased by shaping of the reflection surface and the incidence emission surface in a convex shape. Thus, it is possible to present the large three-dimensional image 300 by emitting light rays at small projection angles without increasing the reciprocation width of the reciprocating motion of the MEMS mirror.

Further, in the case where the MEMS mirror reciprocates, at the time of switching a direction of motion, a rotation speed is preferably reduced for inertial control. In this case, angular intervals between the light rays, among the light rays emitted from the light ray generator 2, in a region in which the direction of reciprocating motion changes (a region outside of an angle of view) is reduced, and angular intervals between the light rays in a region of the center of the angle of view is increased. Even in such a case, the light reflection layer 71 and the light transmission diffusion layer 72 are configured such that the curvature of each of the reflection surface and the incidence emission surface changes locally, whereby angular intervals between the light rays reflected by the light ray controller 7 can be uniform.

Further, even in the case where a lens for fixing the angle of view is provided in the light ray generator 2, it is possible to change the direction of the light ray reflected by the light ray controller 7 by using the light ray controller 7 of which each of the reflection surface and the incidence emission surface have curvature.

FIG. 11 is a schematic diagram showing a configuration of a three-dimensional display according to a second modified example. In the present example, the light ray controller 7 is arranged such that the first direction X is inclined with respect to the vertical direction by a predetermined angle. The light ray controller 7 is inclined such that the incidence emission surface of the light transmission diffusion layer 72 is directed obliquely upward. In this case, the light ray controller 7 can emit a light ray group to a higher space.

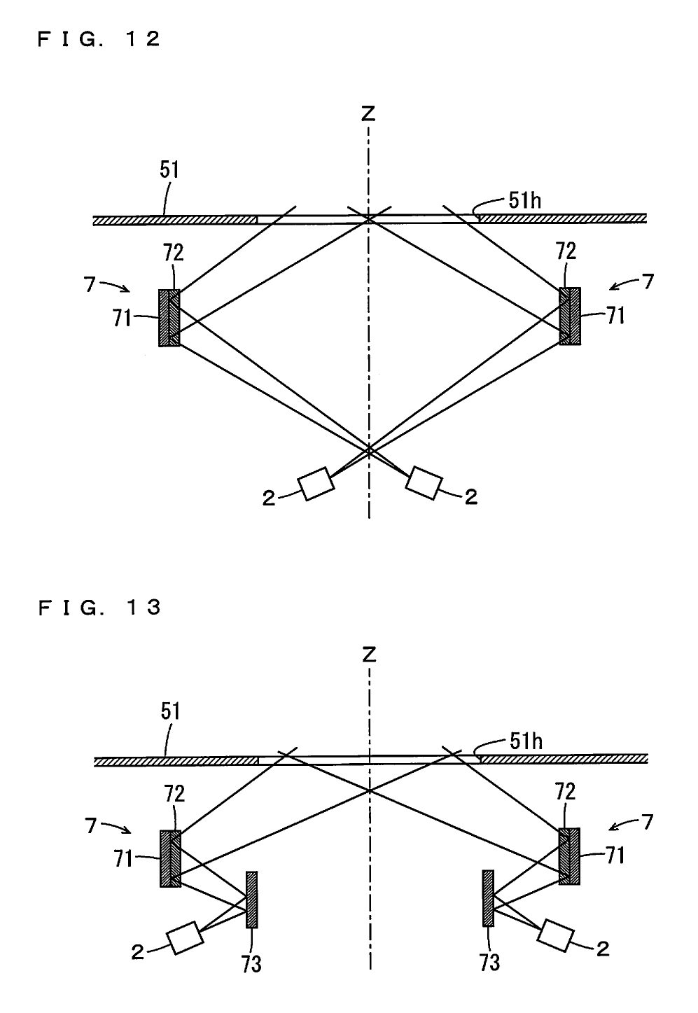

FIG. 12 is a schematic diagram showing a configuration of a three-dimensional display according to a third modified example. In the present example, the light ray generator 2 is arranged on the opposite side to the light ray controller 7 with respect to the center axis Z. In this case, although an angle of view of a scanning projector is small, a large three-dimensional image 300 can be presented. Further, because it is not necessary to increase a scanning range of light rays, the light ray generator 2 can be easily controlled.

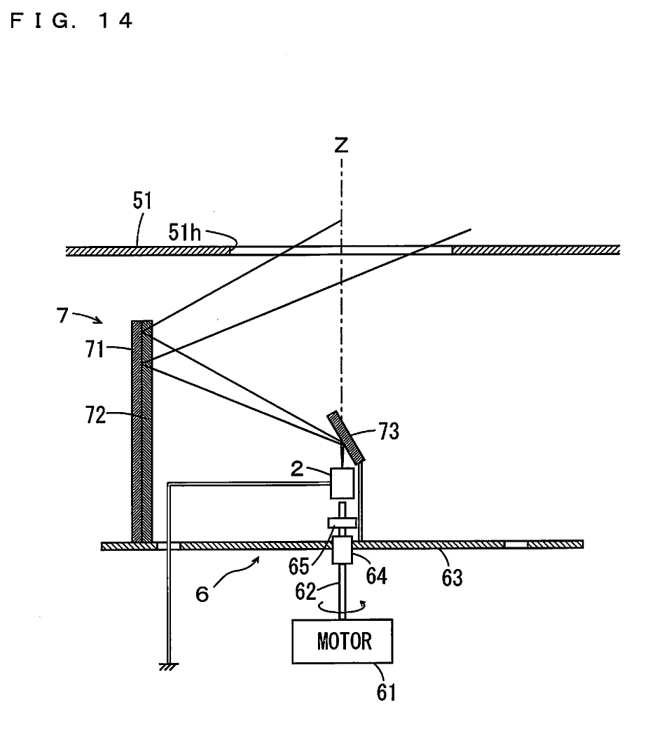

FIG. 13 is a schematic diagram showing a configuration of a three-dimensional display according to a fourth modified example. In the present example, a mirror 73 is arranged on light paths between the light ray controller 7 and the corresponding light ray generator 2. In this case, light rays emitted from the light ray generator 2 are reflected by the mirror 73 and incident on the incidence emission surface of the light transmission diffusion layer 72 of the light ray controller 7. Further, two or more than two mirrors 73 may be arranged on the light paths.

This configuration enables the light paths of the light rays to be further lengthened to be longer than those in the arrangement of the light ray generator 2 of FIG. 12. Therefore, it is possible to present the large three-dimensional image 300 by using a scanning projector having a smaller angle of view. Further, because a scanning range of the light rays can be more sufficiently reduced, the light ray generator 2 can be easily controlled. Further, a degree of flexibility of the arrangement of the light ray generator 2 can be increased.

FIG. 14 is a schematic diagram showing a configuration of a three-dimensional display according to a fifth modified example. In the three-dimensional display according to this fifth modified example, the light ray generator 2 is arranged on the center axis Z, and the mirror 73 is arranged above the light ray generator 2. Light rays emitted from the light ray generator 2 are reflected by the mirror 73 and are incident on the incidence emission surface of the light transmission diffusion layer 72 of the light ray controller 7.

In the fifth modified example, the light ray controller 7 and the mirror 73 are rotated by the rotation module 6, and the light ray generator 2 is not rotated by the rotation module 6. This configuration enables the three-dimensional image 300 to be presented by one set of the light ray generator 2, the light ray controller 7 and the mirror 73.

Further, in the fifth modified example, the mirror 73 is arranged above the light ray generator 2, and the light ray generator 2 emits light rays upward. However, the invention is not limited to this. The mirror 73 may be arranged below the light ray generator 2, and the light ray generator 2 may emit light rays downward.

(7) Effects

In the present embodiment, because the light transmission diffusion layer 72 and the light reflection layer 71 of the light ray controller 7 are laminated on each other, no light path is present between the light transmission diffusion layer 72 and the light reflection layer 71. Therefore, in calculation of the light ray group to be emitted by the light ray generator 2, a positional relationship between the light transmission diffusion layer 72 and the light reflection layer 71 can be excluded from fluctuating parameters. Thus, the calculation process of the light ray group is simplified. Further, the light transmission diffusion layer 72 and the light reflection layer 71 are laminated on each other, so that the light ray controller 7 can be easily manufactured. Further, adjustment of the positional relationship between the light transmission diffusion layer 72 and the light reflection layer 71 is unnecessary. As a result, the accurate three-dimensional image 300 can be more easily displayed.

Correspondences between Constituent Elements in Claims and Parts in Preferred Embodiments

In the following paragraphs, non-limiting examples of correspondences between various elements recited in the claims below and those described above with respect to various preferred embodiments of the present invention are explained.

In the above-mentioned embodiment, the three-dimensional image 300 is an example of a three-dimensional image, the light ray generator 2 is an example of a light ray generator, the light transmission diffusion layer 72 is an example of a light transmission diffusion layer and the light reflection layer 71 is an example of a light reflection layer. The light ray controller 7 is an example of a light ray controller, the rotation module 6 is an example of a rotation mechanism, the control device 3 is an example of a controller, the mirror 73 is an example of a mirror and the camera 8 is an example of a detector.

As each of constituent elements recited in the claims, various other elements having configurations or functions described in the claims can be also used.

### INDUSTRIAL APPLICABILITY

The present invention can be effectively utilized for various types of three-dimensional displays that display three-dimensional images.

1. A three-dimensional display for presenting a three-dimensional image based on three-dimensional data, comprising:
a light ray generator that emits a light ray group including a plurality of light rays;
a light ray controller that includes a light transmission diffusion layer and a light reflection layer laminated on each other; and
a rotation mechanism that rotates the light ray controller about a rotation center axis; and
a controller that controls the light ray generator, wherein the light ray controller is arranged such that the light transmission diffusion layer is located between the rotation center axis and the light reflection layer,
the light ray generator is provided to emit the light ray group towards the light transmission diffusion layer of the light ray controller rotated by the rotation mechanism,
the light transmission diffusion layer is formed to transmit the incident light ray group while diffusing the light ray group in a vertical direction,
the light reflection layer is formed to reflect the light ray group that has been transmitted through the light transmission diffusion layer, and
the controller, based on the three-dimensional data, controls the light ray generator such that a three-dimensional image is presented by the light ray group that has been reflected by the light reflection layer and transmitted through the light transmission diffusion layer.

2. The three-dimensional display according to claim 1, wherein
the rotation mechanism rotates the light ray generator about the rotation center axis together with the light ray controller.

3. The three-dimensional display according to claim 2, wherein
the plurality of light ray controllers are provided,
the plurality of light ray generators are provided to respectively correspond to the plurality of light ray controllers, and
the plurality of light ray generators are provided to emit the light ray group towards the respectively corresponding light ray controllers.

4. The three-dimensional display according to claim 3, wherein
the plurality of light ray controllers and the plurality of light ray generators are arranged around the rotation center axis at equal angular intervals.

5. The three-dimensional display according to claim 1, wherein
the light ray generator is arranged to emit the light ray group in a direction of the rotation center axis,
a mirror that reflects the light ray group emitted by the light ray generator towards the light ray controller is further provided, and
the rotation mechanism rotates the mirror about the rotation center axis together with the light ray controller.

6. The three-dimensional display according to claim 1, further comprising a detector that detects eye positions of an observer, wherein
the controller controls the light ray generator based on the eye positions detected by the detector.

7. The three-dimensional display according to claim 1, wherein
the controller controls a color of a light ray emitted to the light ray controller by the light ray generator for each rotation position of the light ray controller.
